(19) United States
(12) Patent Application Publication
(10) Pub. No.: US 2010/0101316 A1
(43) Pub. Date: Apr. 29, 2010

(54) VALVE STEM CAP

(76) Inventor: Hung-Yi LIN, Taipei County (TW)

Correspondence Address: Muncy, Geissler, Olds & Lowe, PLLC, P.O. BOX 1364, FAIRFAX, VA, 22038-1364, US

(21) Appl. No.: 12/485,176

(22) Filed: Jun. 16, 2009

(30) Foreign Application Priority Data
Oct. 29, 2008 (CN) 200820175923.0

(51) Int. Cl. B60C 23/04

(52) U.S. Cl. 73/146.8

(57) ABSTRACT

A valve stem cap to be coupled with the inlet/outlet end of a tire valve stem includes a connecting seat having a closed end fitted with a sealing washer and an open end having a threaded hole for coupling with the tire valve stem. An external thread is formed on an outer tubular surface of the connecting seat near the closed end for coupling threadingly with a threaded hole of a light penetrable cover and thereby enclosing a light-emitting unit in the light penetrable cover. The light-emitting unit includes first and second conductive plates electrically connected by a conducting element and at least one battery. When the tire valve stem, coupled with the valve stem cap, leaks, a light-emitting diode on a top surface of the first conductive plate emits light as an alert. Meanwhile, the valve stem cap stops the leak so as to maintain an acceptable tire pressure.

### BACKGROUND OF THE INVENTION

1. Technical Field

The present invention relates to valve stem caps and, more particularly, to a valve stem cap to be mounted on the valve stem of an ordinary tire so as to provide leakage alert and stop air leakage from the valve stem.

2. Description of Related Art

The tires of an automobile or motorcycle can be rotated under vehicle load and help the vehicle move smoothly forward only when the tires are sufficiently inflated to the specified pressure. Tires are inflated through valve stems on the tires. The valve stem of a tire is a one-way valve that prevents air pumped into the tire from flowing out and thereby maintains the specified tire pressure. However, the anti-leak element in the valve stem will degrade after long-term use and consequently fail to block the air in the tire from leaking. A general valve stem cap for closing the inlet/outlet end of a valve stem only serves to prevent dust or foreign objects from entering the valve stem but does not stop air leakage. Therefore, if a driver fails to check the tire condition of a vehicle before driving, the vehicle may run on under-pressure tires without the driver's knowing it, thus increasing the chances of traffic accidents.

Presently, many tire pressure alert devices are known, including for example Taiwan Patent No. TWI282316, titled “Multi-Functional Device Serving as Anti-Theft Car Lock and Tire Pressure Detector”; Taiwan Patent No. TWM288598, titled “Tire Valve Stem Having Tire Pressure Alert device”; and Taiwan Patent No. TWM275972, titled “Tire Pressure Alert Device Capable of Adjusting the Settings for Tire Pressure Measurement and Detection”. While the devices disclosed in the above-cited patents provide tire pressure detection and alert, a leaking tire can be detected only when the vehicle is in a driving state and thus enables an on-board computer to receive corresponding signals. Moreover, even if a leaking tire is detected, these patented devices cannot stop the leakage instantly and therefore do not provide further protection to vehicles which are running on the road and whose leaking tires are hence impossible to get inflated immediately.

### BRIEF SUMMARY OF THE INVENTION

In view of the abovementioned drawbacks of conventional tire pressure detectors, the present invention provides a valve stem cap capable of emitting light as a leakage alert before the vehicle is started and without using any computer equipment in the vehicle.

The present invention also provides a valve stem cap capable of immediately stopping air leakage from a valve stem so as to maintain an acceptable tire pressure.

The valve stem cap according to the present invention is intended as a substitution for the conventional valve stem caps and is configured for coupling directly with the inlet/outlet end of a valve stem. More particularly, the valve stem cap of the present invention includes a connecting seat, a sealing washer, a light-emitting unit, and a light penetrable cover. The connecting seat is a tube having a closed end and an open end, wherein the closed end has a recess centrally formed with a through hole, and the open end has a threaded hole. In addition, the connecting seat has an outer tubular surface formed with an external thread that extends downward from the closed end. The sealing washer is placed in the recess of the connecting seat and has a top surface provided with a conductive block. The light-emitting unit includes a first conductive plate, a second conductive plate, a conducting element, and at least one battery. The first and second conductive plates are disposed at and electrically connected to an upper end and a lower end of the conducting element, respectively. The at least one battery is located inside the conducting element while an insulating layer is provided between the at least one battery and the conducting element. The first conductive plate has a top surface provided with a light-emitting diode. The second conductive plate has a top surface provided with a conducting surface for electrically connecting a bottom surface of the at least one battery. The second conductive plate also has a bottom surface provided with two contacts that form an open circuit. Moreover, the second conductive plate is settled on top ends of the connecting seat and of the sealing washer such that the two contacts on the bottom surface of the second conductive plate hang spacedly over the conductive block of the sealing washer. The light penetrable cover has a lower open end formed with a threaded hole for coupling threadingly with the external thread of the connecting seat and thereby enclosing the light-emitting unit in the light penetrable cover.

In the valve stem cap of the present invention, the connecting seat is formed with a neck downward of the external thread, and a first watertight 0-ring is mounted around the neck and coupled hermetically with the lower open end of the light penetrable cover.

In the valve stem cap of the present invention, the outer tubular surface of the connecting seat is provided with an anti-slip embossed pattern downward of the neck so as to facilitate the operation of coupling the valve stem cap threadingly with the valve stem.

In the valve stem cap of the present invention, the conducting element of the light-emitting unit is a metal tube, the insulating layer is an insulating tube, and the conducting surface of the second conductive plate is provided by two upwardly turning resilient tongues or by an upwardly projecting conductive foam.

In the valve stem cap of the present invention, the conducting element of the light-emitting unit is a metal tube, the insulating layer is an insulating surface provided on a surface of the metal tube that is adjacent to the at least one battery, and the conducting surface of the second conductive plate is provided by two upwardly turning resilient tongues or by an upwardly projecting conductive foam. The insulating surface provided on the surface of the metal tube that is adjacent to the at least one battery is provided by a coating of insulating paint or by an anodized, insulating plated layer.

In the valve stem cap of the present invention, the conducting element of the light-emitting unit is a metal coil with adjustable height, the insulating layer is an insulating tube, and the conducting surface of the second conductive plate is provided by two upwardly turning resilient tongues or by an upwardly projecting conductive foam, or is a fixed conducting surface.

In the valve stem cap of the present invention, a second watertight 0-ring is provided at a top portion of the threaded hole of the connecting seat so as for the valve stem cap to couple hermetically with the valve stem and thereby prevent air leakage through the threadingly coupled portion between the valve stem cap and the valve stem.

When a tire valve stem coupled with the valve stem cap of the present invention malfunctions and leaks, the leaking gas rushes through the through hole formed in the recess at a top portion of the connecting seat and strikes a generally central portion of a bottom surface of the sealing washer. As a result, the sealing washer is curved, causing the conductive block on the top surface of the sealing washer to contact the two contacts of the second conductive plate simultaneously and thereby close the originally open circuit. The light-emitting diode is thus turned on to emit light that propagates outward through the light penetrable cover and serves as a leakage alert. While the light-emitting diode emits the alerting light, the leaking gas is sealed between the sealing washer and the end of the tire valve stem and will not leak further outward. This is because the top surface of the tire valve stem is coupled hermetically with the connecting seat via the second watertight O-ring, and the sealing washer is pressed tightly against the recess at the top portion of the connecting seat.

Hence, the valve stem cap of the present invention is advantageously capable of replacing the conventional valve stem caps that only serve a covering function, providing immediate alert when a valve stem coupled with the valve stem cap leaks, and stopping the leak immediately so as to maintain an acceptable tire pressure until the leaking valve stem is repaired.

### BRIEF DESCRIPTION OF THE SEVERAL VIEWS OF THE DRAWINGS

The invention as well as a preferred mode of use, further objectives, and advantages thereof will be best understood by referring to the following detailed description of preferred embodiments in conjunction with the accompanying drawings, wherein:

FIG. 1 is a perspective view of a valve stem cap according to a first embodiment of the present invention;

FIG. 2 is an exploded perspective view of the valve stem cap according to the first embodiment of the present invention;

FIG. 3 is a sectional perspective view of the valve stem cap according to the first embodiment of the present invention in an assembled state;

FIG. 4 is a sectional view of the valve stem cap according to the first embodiment of the present invention, wherein the valve stem cap is coupled with a tire valve stem;

FIG. 5 is a sectional view showing operation of the valve stem cap in FIG. 4 when the tire valve stem leaks;

FIG. 6 is a sectional view of a valve stem cap according to a second embodiment of the present invention, wherein the valve stem cap is coupled with a tire valve stem, and a metal coil is used as the conducting element of a light-emitting unit;

FIG. 7 is a partial sectional view of a valve stem cap according to a third embodiment of the present invention, wherein the conducting surface of a second conductive plate of the light-emitting unit is provided by a conductive foam block; and

FIG. 8 is a partial sectional view of a valve stem cap according to a fourth embodiment of the present invention, wherein the conducting element of the light-emitting unit has an inner insulating layer.

### DETAILED DESCRIPTION OF THE INVENTION

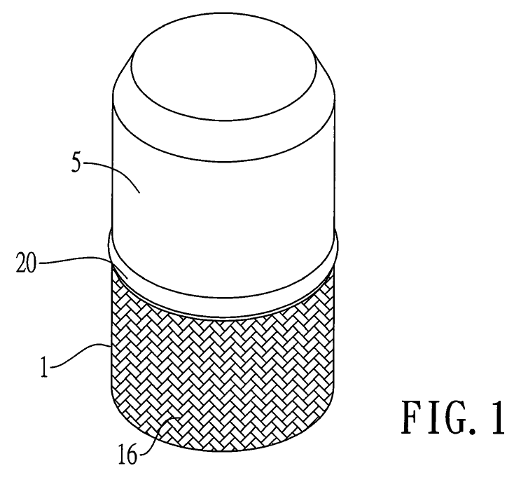

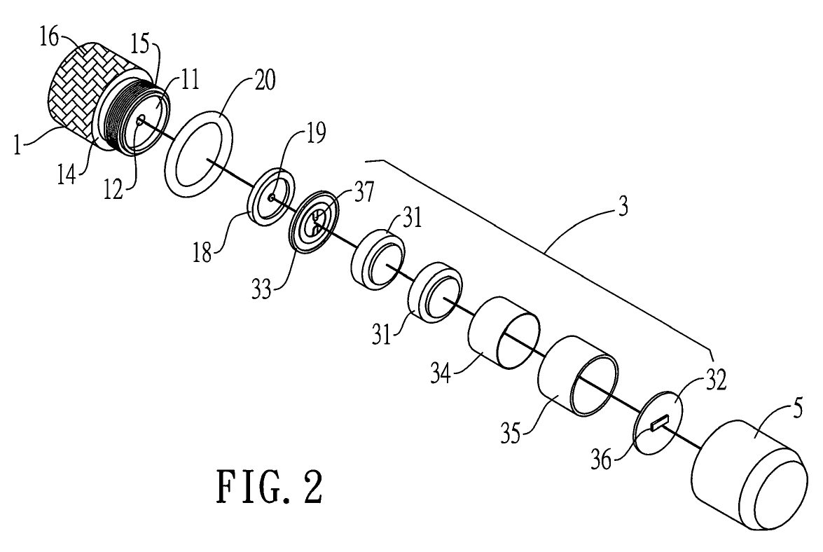

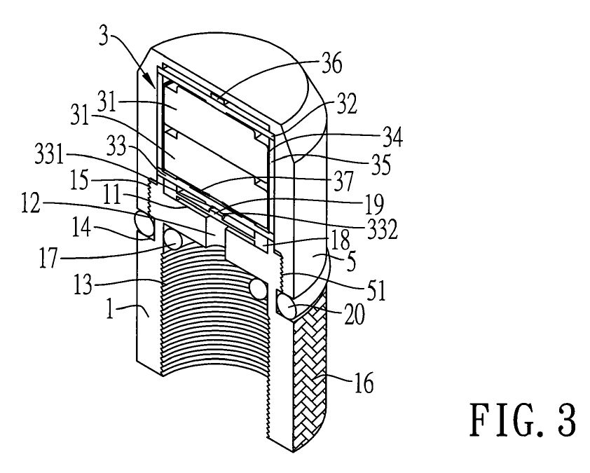

Referring to FIG. 1 through FIG. 3, a valve stem cap according to a first preferred embodiment of the present invention includes a connecting seat 1, a light-emitting unit 3, and a light penetrable cover 5. The connecting seat 1 is a tube having a closed end and an open end, wherein the closed end has a recess 11 centrally formed with a through hole 12, and the open end has a threaded hole 13. A watertight O-ring 17 is provided at a top portion of the threaded hole 13. A neck 14 is formed externally on a middle section of the connecting seat 1. The connecting seat 1 has a tubular surface formed with an external thread 15 upward of the neck 14 and an anti-slip embossed pattern 16 downward of the neck 14. A sealing washer 18 is disposed in the recess 11 of the connecting seat 1 and has a top surface provided with a conductive block 19. In addition, a watertight O-ring 20 is mounted around the neck 14 of the connecting seat 1.

The light-emitting unit 3 includes at least one battery 31 (two batteries 31 are shown in the present preferred embodiment), a first conductive plate 32, a second conductive plate 33, and a conducting element for electrically connecting the first and second conductive plates 32, 33. In the first preferred embodiment, the connecting element is a metal tube 35, and the batteries 31 are received in the metal tube 35. In order to prevent short circuit from occurring due to electrical connection between the batteries 31, the first conductive plate 32, and the second conductive plate 33, it is necessary to have insulation measures in place, such as an insulating layer between the metal tube 35 and the batteries 31. The insulating layer can be provided by a coating of insulating paint or an anodized, insulating plated layer on an inner surface of the metal tube 35. Alternatively, as in the present preferred embodiment, the insulating layer is an insulating tube 34 disposed between the metal tube 35 and the batteries 31.

The first conductive plate 32 of the light-emitting unit 3 has a top surface and a bottom surface, wherein the top surface is provided with a light-emitting diode 36, and the bottom surface has a peripheral portion electrically connected to an upper end of the metal tube 35 and a central portion electrically connected to the batteries 31. The second conductive plate 33 also has a top surface and a bottom surface, wherein the top surface has two upwardly turning resilient tongues 37, and the bottom surface is provided with two contacts 331 and 332 that form an open circuit. The top surface of the second conductive plate 33 has a peripheral portion electrically connected to a lower end of the metal tube 35 such that the two upwardly turning resilient tongues 37 are electrically connected to a bottom end of the batteries 31, and in consequence a top end of the batteries 31 is constantly in contact with the bottom surface of the first conductive plate 32. Furthermore, the second conductive plate 33 is settled on top ends of the connecting seat 1 and of the sealing washer 18 such that the two contacts 331 and 332 on the bottom surface of the second conductive plate 33 hang spacedly over the conductive block 19 of the sealing washer 18.

The light penetrable cover 5 has a lower open end formed with a threaded hole 51 for coupling threadingly with the external thread 15 of the connecting seat 1 and thereby enclosing the light-emitting unit 3 in the light penetrable cover 5. The light penetrable cover 5 allows light emitted by the light-emitting diode 36 of the light-emitting unit 3 to pass through and propagate outward.

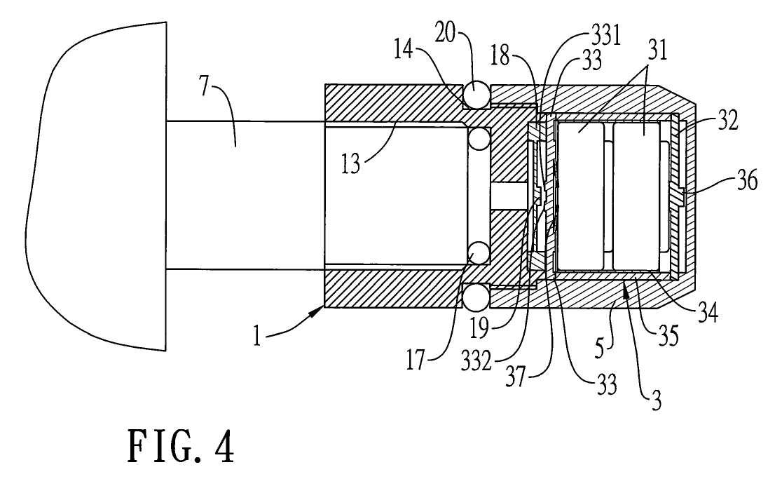

To use the valve stem cap of the present invention, referring to FIG. 4, the threaded hole 13 of the connecting seat 1 is coupled threadingly with a tire valve stem 7 such that the watertight O-ring 17 at the top portion of the threaded hole 13 is hermetically coupled with a top surface of the tire valve stem 7. Thus, in case the tire valve stem 7 leaks, the leaking air is prevented from discharging through an otherwise existing gap between the threaded hole 13 of the connecting seat 1 and the tire valve stem 7. On the other hand, the watertight O-ring 20 mounted around the connecting seat 1 is coupled with the lower open end of the light penetrable cover 5 to effectively prevent moisture from entering the valve stem cap through an otherwise existing gap and thereby protect internal components of the valve stem cap. When the tire valve stem 7 functions properly without leaking, the first and second conductive plates 32, 33 of the light-emitting unit 3 are electrically connected by the metal tube 35, and the batteries 31 are electrically connected between the first and second conductive plates 32, 33; however, the open circuit formed by the two contacts 331 and 332 on the bottom surface of the second conductive plate 33 still prevents the light-emitting diode 36 on the top surface of the first conductive plate 31 from being turned on.

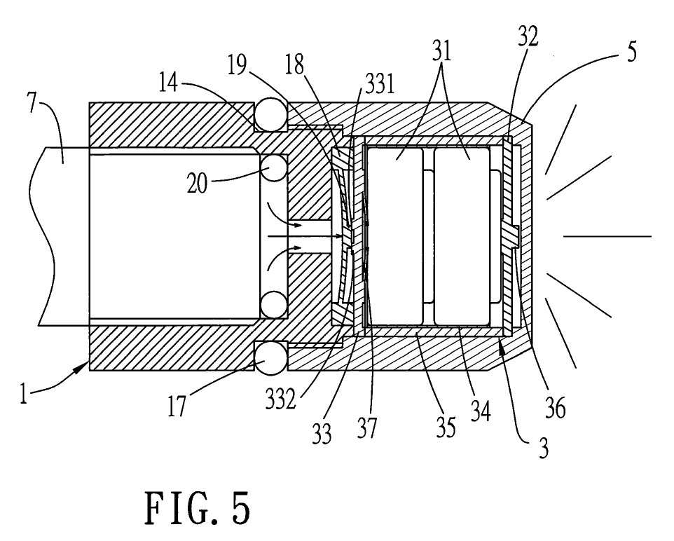

However, as shown in FIG. 5, when the tire valve stem 7 no longer functions normally such that air leaks therefrom, the leaking air will rush through the through hole 12 formed centrally in the recess 11 at a top portion of the connecting seat 1 (in directions indicated by the central arrows in FIG. 5) and strike a generally central portion of a bottom surface of the sealing washer 18. In consequence, the sealing washer 18 is curved, and the conductive block 19 on the top surface of the sealing washer 18 makes contact with the two contacts 331 and 332 of the second conductive plate 33 concurrently, thus closing the originally open circuit and turning on the light-emitting diode 36. Light emitted by the light-emitting diode 36 will propagate outward through the light penetrable cover 5 and serve as a leakage alert.

As the watertight O-ring 17 forms a hermetic seal between the top surface of the tire valve stem 7 and the connecting seat 1, and the sealing washer 18 is pressed tightly against the recess 11 formed at the top portion of the connecting seat 1, when the light-emitting diode 36 is triggered by an air leak to generate a leakage alert, the leaking air is contained between the sealing washer 18 and the outlet of the tire valve stem 7 and prevented from leaking out. By the same token, no more air will escape from the tire valve stem 7. Thus, the valve stem cap of the present invention serves the dual function of providing leakage alert and stopping air leak.

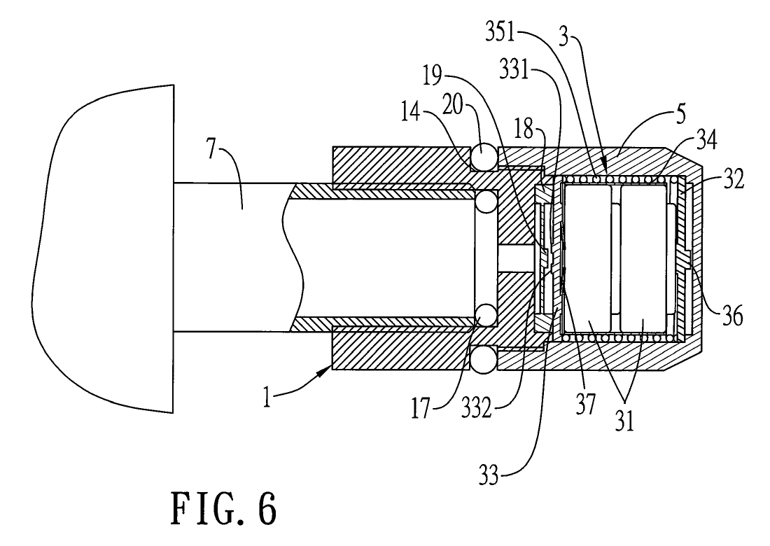

Refer to FIG. 6 for a valve stem cap according to a second preferred embodiment of the present invention. The valve stem cap of the second preferred embodiment is structurally identical to that of the first preferred embodiment, except that the metal tube 35 in the first preferred embodiment is replaced by a height-adjustable spring-like metal coil 351. The metal coil 351 makes electrical contact with the first and second conductive plates 32, 33 more resiliently and more securely than the metal tube 35. Hence, it is contemplated to replace the conducting surface provided by the resilient tongues 37 on the top surface of the second conductive plate 33 with a fixed conducting surface. In the second preferred embodiment, however, the resilient tongues 37 remain.

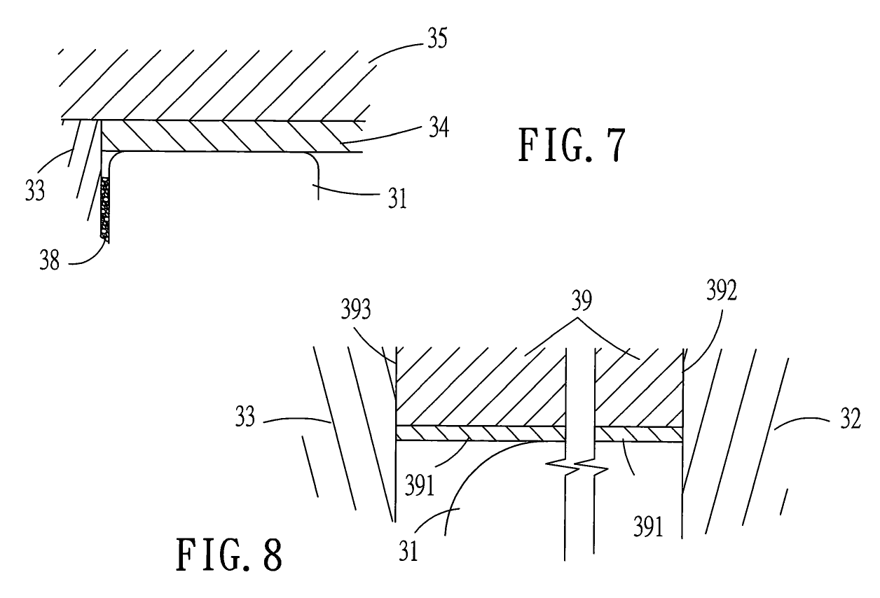

FIG. 7 shows a third preferred embodiment of the present invention, which is structurally identical to the first preferred embodiment except that the conducting surface provided by the two resilient tongues 37 on the top surface of the second conductive plate 33 in the first preferred embodiment is provided in the third preferred embodiment by a conductive foam block 38, which is compressible and restorable in shape. The conductive foam block 38 may also substitute the resilient tongues 37 in the first and second preferred embodiments of the present invention.

FIG. 8 illustrates a fourth preferred embodiment of the present invention. In contrast to the insulating tube 34 that is used in the first to third preferred embodiments to electrically isolate the batteries 31 from the metal tube 35 or the metal coil 351, a metal tube 39 in the fourth preferred embodiment has an inner tubular surface that is adjacent to the batteries 31 and subjected to an insulation treatment such that an insulating layer 391 or insulating surface is formed, and in consequence the metal tube 39 makes insulated contact with the batteries 31 while an upper end surface 392 and a lower end surface 393 of the metal tube 39 are electrically connected to the first and second conductive plates 32 and 33, respectively.

While the present invention is demonstrated herein by reference to the preferred embodiments, it is understood that the embodiments are not intended to limit the scope of patent protection for the present invention, if granted, and variations or modifications based on the technical features described above are readily conceivable by a person of ordinary skill in the art. Therefore, the precise scope of patent protection for the present invention is defined only by the appended claims.

What is claimed is:

1. A valve stem cap, to be coupled with an inlet/outlet end of a valve stem, the valve stem cap comprising:
a connecting seat formed as a tube having a closed end and an open end, wherein the closed end has a recess centrally formed with a through hole, the open end has a threaded hole, and the connecting seat has an outer tubular surface formed with an external thread extending downward from the closed end;
a sealing washer disposed in the recess of the connecting seat and having a top surface provided with a conductive block;
a light-emitting unit comprising a first conductive plate, a second conductive plate, a conducting element, and at least a battery, wherein the first conductive plate and the second conductive plate are electrically connected to an upper end and a lower end of the conducting element, respectively, the at least a battery is disposed inside the conducting element, and an insulating layer is provided between the at least a battery and the conducting element, wherein the first conductive plate has a top surface provided with a light-emitting diode, the second conductive plate has a top surface provided with a conducting surface for electrically connecting with a bottom surface of the at least a battery and a bottom surface provided with two contacts forming an open circuit, and the second conductive plate is settled on top ends of the connecting seat and of the sealing washer such that the two contacts on the bottom surface of the second conductive plate hang spacedly over the conductive block of the sealing washer; and
a light penetrable cover having a lower open end formed with a threaded hole for coupling threadingly with the external thread of the connecting seat and thereby enclosing the light-emitting unit in the light penetrable cover.

2. The valve stem cap of claim 1, wherein a neck is provided downward of the external thread of the connecting seat, and a watertight O-ring is mounted around the neck and coupled hermetically with the lower open end of the light penetrable cover.

3. The valve stem cap of claim 2, wherein the outer tubular surface of the connecting seat is provided with an embossed pattern downward of the neck.

4. The valve stem cap of claim 1, wherein the conducting element of the light-emitting unit is a metal tube, the insulating layer is an insulating tube, and the conducting surface of the second conductive plate is provided by two upwardly turning resilient tongues.

5. The valve stem cap of claim 1, wherein the conducting element of the light-emitting unit is a metal tube, the insulating layer is an insulating tube, and the conducting surface of the second conductive plate is provided by an upwardly projecting conductive foam.

6. The valve stem cap of claim 1, wherein the conducting element of the light-emitting unit is a metal tube, the insulating layer is an insulating surface provided on a surface of the metal tube that is adjacent to the at least a battery, and the conducting surface of the second conductive plate is provided by two upwardly turning resilient tongues.

7. The valve stem cap of claim 6, wherein the insulating surface provided on the surface of the metal tube that is adjacent to the at least a battery is provided by a coating of insulating paint or by an anodized, insulating plated layer.

8. The valve stem cap of claim 1, wherein the conducting element of the light-emitting unit is a metal tube, the insulating layer is an insulating surface provided on a surface of the metal tube that is adjacent to the at least a battery, and the conducting surface of the second conductive plate is provided by an upwardly projecting conducting foam.

9. The valve stem cap of claim 1, wherein the conducting element of the light-emitting unit is a height-adjustable metal coil, and the insulating layer is an insulating tube.

10. The valve stem cap of claim 1, further comprising another watertight O-ring provided at a top portion of the threaded hole of the connecting seat.
